(19) United States
(12) Patent Application Publication
(10) Pub. No.: US 2007/0121496 A1
(43) Pub. Date: May 31, 2007

(54) System and method for amplitude optimization in high-speed serial transmissions

(76) Inventors: Joshua P. Sinykin, Colorado Springs, CO (US); Gabriel Leandro Romero, Colorado Springs, CO (US)

Correspondence Address: LSI Logic Corporation;Legal Department - IP, 1621 Barber Lane, MS D-106, Milpitas, CA, 95035, US

(21) Appl. No.: 11/290,786

(22) Filed: Nov. 30, 2005

(51) Int. Cl. H04L 12/26; H04B 1/44

(52) U.S. Cl. 370/229; 370/282

(57) ABSTRACT

A method, system, and computer usable program code for increasing drive strength using various steps. First, a data signal is received at a receiving device. The receiving device determines whether the data is successfully received once the data signal is received at the receiving device. If the receiving device determines that the data signal is unsuccessfully received, the receiving device requests an increase in a signal amplitude of the data signal transmitted by a transmitting device that sent the data signal for increasing the drive strength.

### BACKGROUND OF THE INVENTION

1. Technical Field

The present invention is directed generally toward data processing and particularly, to a computer implemented method and system for amplitude modification in high-speed data transmissions.

2. Description of the Related Art

High speed serial data transfer has grown progressively more important in recent years because of technological improvements and high-speed computing requirements. Complex computer software, circuitry, and peripherals as well as ever-increasing bandwidth and processing speeds have made reliable high speed data transmissions crucial. As a result, it has become increasingly difficult to maintain signal integrity within technical and cost requirements.

Data transmission lines inherently have some resistance as well as parasitic inductance and capacitance that have degrading effects on high-speed serial transmissions. The longer the line, the more pronounced the effects on a transmission signal and the more difficult the signal is to decode the data.

Signal attenuation and integrity also varies depending on the operation environment which is affected by many elements including component quality, conductor composition, cabling, and interconnections. Attenuation is a decrease in signal amplitude as it travels through any transmitting medium, such as a cable or circuitry, due to as it is deflection and absorption. These varying conditions increase the likelihood of communication errors between a transmitter and receiver and require more time and expense in troubleshooting and system modification. A decrease in the received signal amplitude is especially likely to affect the effectiveness of communications between the transmitter and receiver.

Many systems include elements for error correction in the event a received signal is unacceptable or incorrupt. Error correction usually requests that the signal be retransmitted. Retransmitting a signal is only effective if the subsequent signal is properly received in an acceptable format.

### SUMMARY OF THE INVENTION

A method, system, and computer usable program code for increasing drive strength using various steps. First, a data signal is received at a receiving device. The receiving device determines whether the data is successfully received once the data signal is received at the receiving device. If the receiving device determines that the data signal is unsuccessfully received, the receiving device requests an increase in a signal amplitude of the data signal transmitted by a transmitting device that sent the data signal for increasing the drive strength.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a pictorial representation of a data processing system in which the aspects of the present invention may be implemented;

FIG. 2 is a block diagram of a data processing system is shown in which the present invention may be implemented;

FIG. 3 is a block diagram of a transmitter and receiver system in accordance with an illustrative embodiment of the present invention;

FIG. 4 is a block diagram of an interface system in accordance with an illustrative embodiment of the present invention;

FIG. 5 is a block diagram of an interconnected transmitter and receiver in accordance with an illustrative embodiment of the present invention;

FIG. 6 is a flowchart illustrating amplitude modification in a receiving expander in accordance with an illustrative embodiment of the present invention; and

FIG. 7 is a flowchart illustrating amplitude modification in a transmitting host bus adapter in accordance with an illustrative embodiment of the present invention.

### DETAILED DESCRIPTION

The description of the preferred embodiment of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention the practical application to enable others of ordinary skill in the art to understand the invention for various embodiments with various modifications as are suited to the particular use contemplated.

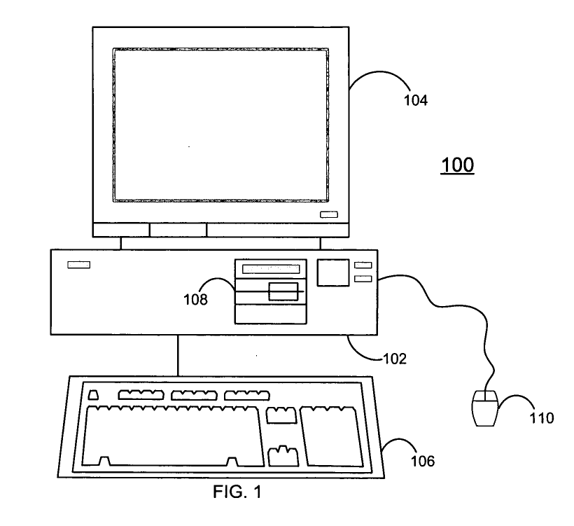

With reference now to the figures and in particular with reference to FIG. 1, a pictorial representation of a data processing system in which the aspects of the present invention may be implemented. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

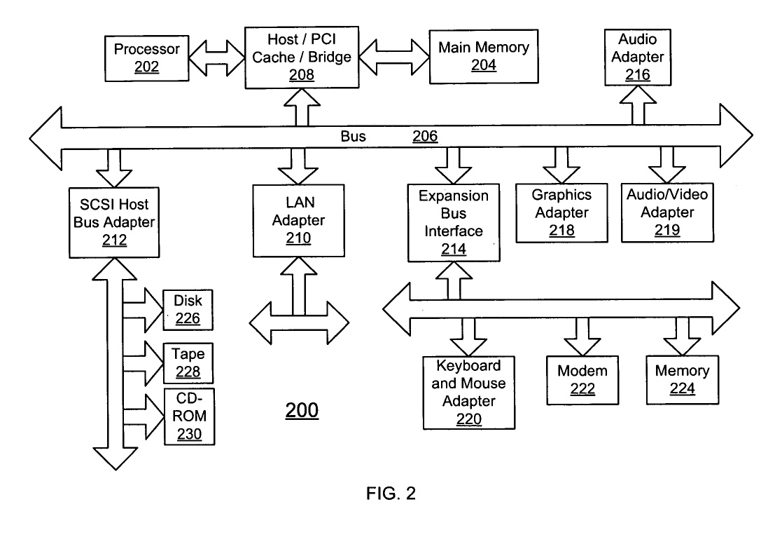

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a SAS and PCI bus, other bus architectures and standards such as Serial Advanced Technology Attachment (SATA) interface, Accelerated Graphics Port (AGP), and Industry Standard Architecture (ISA) may be used. Processor 202 and main memory 204 are connected to PCI local bus 206 through PCI bridge 208. A controller as used herein may refer generally to a processing element or an application specific integrated circuit (ASIC) or the combination thereof. PCI bridge 208 also may include an integrated memory controller and cache memory for processor 202. Additional connections to PCI local bus 206 may be made through direct component interconnection or through add-in connectors. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Hard disk drive 226 and CD-ROM drive 230 may use, for example, a serial advanced technology attachment (SATA) interface, or serial attached small computer system interface (SAS). Typical PCI local bus implementations will support three or four PCI expansion slots or add-in connectors.

An operating system runs on processor 202 and coordinates and provides control of various components within data processing system 200 in FIG. 2. Instructions for the operating system, the object-oriented programming system, and applications or programs are located on storage devices, such as hard disk drive 226, and may be loaded into main memory 204 for execution by processor 202. The processes of the present invention are performed by processor 202 using computer implemented instructions, which may be located in a memory such as, for example, main memory 204, additional memory 224, or in one or more peripheral devices.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

n some illustrative examples, data processing system 200 may be a personal digital assistant (PDA), which is configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 204 or a cache memory. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The different embodiments of the present invention provides a computer implemented method, system, and computer usable code that allows a transmitter host and receiver device connected system to dynamically modify signal amplitude. In illustrative embodiments of the present invention, the transmitting host or transmitter may be any of a host bus adapter, root complex, Ethernet host, a Fibre switch, or other transmitting host. The receiving device or receiver may be a host bus adapter, expander, peripheral component interconnect (PCI) express device, Ethernet target, Fibre switch, or other receiving target. During a data transmission sequence, the receiver communicates whether the transmitted data is successfully received. Data is successfully received if the data can be extracted by the receiver from the transmitted signal received. If the amplitude corresponding with the drive strength is insufficient for adequate data recover, the receiver tells the transmitter to incrementally increase the amplitude drive strength.

The signal amplitude is incrementally increased until the data signal is properly received without data loss or until the amplitude drive strength is at the maximum level. If the drive strength is at the maximum level and there is inadequate data reception an error message is reported so the calling software can report a bad link. The transmitter may also use a timer to automatically increase the drive strength if the data signal is not properly received by the receiver.

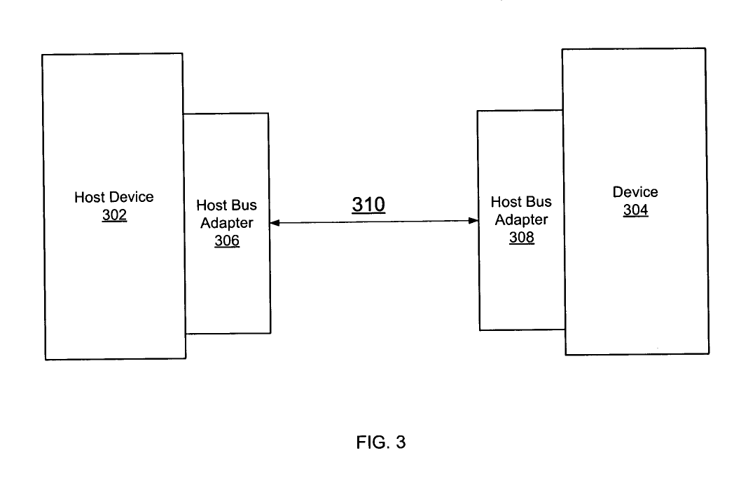

FIG. 3 is a block diagram of a transmitter and receiver system in accordance with an illustrative embodiment of the present invention. Host device 302 and device 304 are each operably connected to host bus adapters 306 and 308 respectively. Host bus adapter 306 of FIG. 3 may be connected to a bus interface such as PCI local bus 206 of FIG. 2 and host bus adapter 308 of FIG. 3 may be an expander or bus adapter such as SCSI host bus adapter 212 of FIG. 2.

Returning again to FIG. 3, host bus adapter 306 of host device 302 connects to host bus adapter 308 of device 304 by conductor 310. Host device 302 and device 304 may represent any number of interconnected devices. For example, host device 302 and device 304 may indirectly interconnect a processor of a computing device with a high-speed disk drive by means of a serial cable. Other types of devices and systems may send and receive data using the method of host device 302 and device 304 herein described. Device 304 may be any storage device or drive such as disk 226, tape 228, or CD-ROM 230 of FIG. 2.

Conductor 310 is any medium that can carry or conduct signals between host bus adapter 306 and host bust adapter 308. This component may be, for example, a wire trace or a backplane of a motherboard connecting embedded or module components. Conductor 310 may also be a interchangeable cabling element where any given cable may have different impedance characteristics. Conductors as herein defined is any wire, path, trace, backplane, etch, pad, channel, medium, or material that allows an electric data transmission to pass through the conductor in the form of transmission medium.

Different conductor types may change the attenuation of the data signal as it is transmitted. As a result, host bus adapter 306 is equipped to transmit at different drive amplitudes. In one example, host bus adapter 306 is equipped with a register that sets the amplitude level of a transmitted signal. The register may include various hexadecimal values with incrementing amplitude represented by letters A through F. An appropriate register change request changes the register value thereby increasing or decreasing the transmitted amplitude level.

Host bus adapter 306 is equipped with a default amplitude level. In another illustrative embodiment, the default amplitude level may be set by a user. The amplitude level relates to the drive strength of the host bus adapter. Amplitude is generally defined as the maximum value of electromagnetic waves within a signal measured from the mean to the crest. In the present invention, amplitude is the magnitude or height of the signal in terms of volts and sufficient amplitude is necessary to allow data extraction from a transmitted signal. The drive strength and corresponding amplitude must be sufficiently high in a transmitted signal to allow host bus adapter 308 to distinguish between data bits transmitted in the form of a wave.

For example, a user may desire to optimally set the drive strength of the host bus adapter 306 in order to conserve power and. minimize electromagnetic interference by setting the default value to the minimum drive strength. As a result, the drive strength may be incrementally increased until the transmitted data signal is successfully received by host bus adapter 308. Host bus adapter 308 may include various threshold requirements, such as peak-to-peak amplitude, that must be met in order for data extraction from the transmitted signal. Incrementally increasing the drive strength to the minimal level necessary for successful data retrieval minimizes power requirements and reduces electromagnetic interference with other devices. The range of possible amplitudes may vary dramatically depending on distance. In one illustrative embodiment, the amplitude range is between 15 and 200 millivolts.

In another illustrative embodiment, the drive strength may be remotely increased or activated by sending a request through a networking mechanism in which the device driver receives the command to increase the drive strength. For example, a user noting communications errors or the lack of communication between devices may send a call or register change request through host device 302 that tells a host bus adapter driver to increase the drive strength in host bus adapter 306.

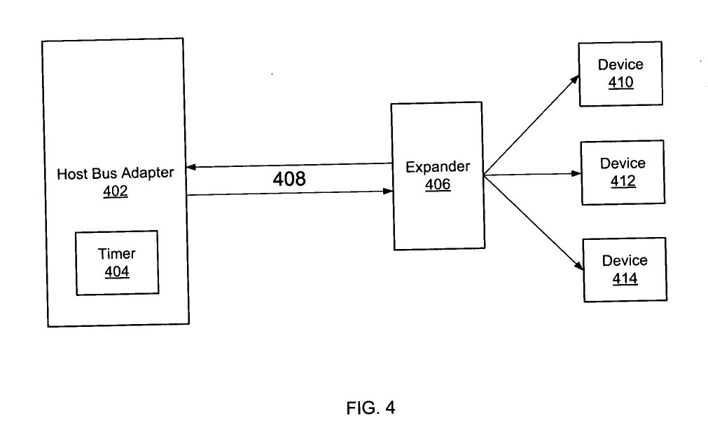

FIG. 4 is a block diagram of an interface system in accordance with an illustrative embodiment of the present invention. Host bus adapter 402 is an I/O adapter or card that sits between the host computer's bus and a fibre channel loop or small computer system interface device allowing the host and a device to communicate. Host bust adapter 402 preferably incorporates timer 404 that may be programmed with a specific time period. Host bus adapter 402 is operably connected to expander 406 by conductor 408. Conductor 408 is a transmitting medium that allows host bus adapter 402 and expander 406 to mutually send and receive information.

Expander 406 functions as a router for devices 410, 412, and 414. Devices 410, 412, and 414 may be a hard disk drive, tape drive, or CD-ROM. Expander 406 is preferably is connected to one or more device at any given time.

Data may be analyzed in various ways. In one illustrative embodiment, the signal is automatically analyzed to determine if the data is successfully received whenever data is sent by host bus adapter 402. In another illustrative embodiment, host bus adapter 402 and expander 406 may establish a training link or sequence for establishing the appropriate amplitude level. The training sequence is used to train host bus adapter 402 to send a signal with optimal amplitude in order to ensure successful data reception and reduce errors at expander 406. In yet another embodiment, the training link may be used to decrease the amplitude drive strength until data reception errors occur at which point the drive strength is increased by host bus adapter 402 until the transmitted data is properly received.

As previously mentioned, communications between host bus adapter 402 and expander 406 may use various interface types. For example, serial advanced technology attachment (SATA) is an interface that sends information one bit a time to achieve high transmission speeds. Serial advanced technology attachment is often used to attach integrated drive electronics (IDE) drives to a computer. Another exemplary interface, is serial attached small computer system interface (SAS) and peripheral component interconnect express, a high-speed serial interface that serves as an expansion bus that can be used to connect hard disk drives, tape drive, and other hardware components. Successfully transmitted data is data sent and received without any disparity or decoding errors as defined by the interface protocol.

Each possible interface type inherently incorporates various error capturing/detection methods applicable for data analysis. For example, an alarm indicating that the receiving device has loss of signal (RXLOS). RXLOS may indicate the signal is damaged, distorted, insufficient, or otherwise unintelligible. Other equivalent error signals may include R_ERROR or Negative Acknowledgement (NAK) indicating to the transmitter that the data received is missing, corrupt, or unacceptable.

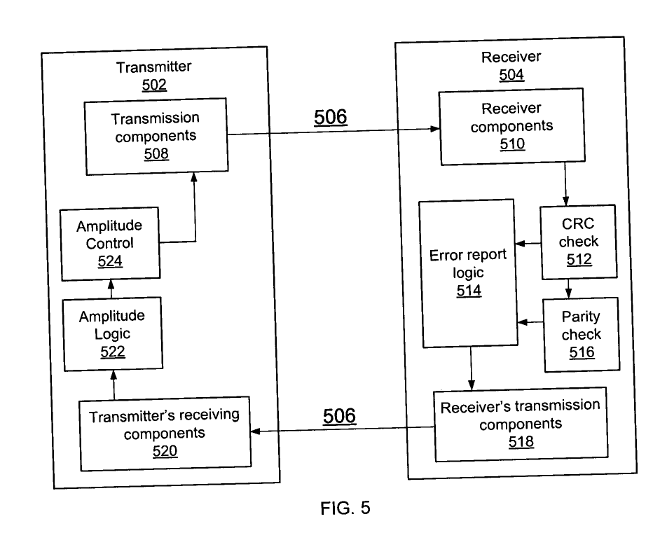

FIG. 5 is a block diagram of an interconnected transmitter and receiver in accordance with an illustrative embodiment of the present invention. Transmitter 502 and receiver 504 are operably connected by conductor 506 for serial transmissions. Transmitter 502 may be a transmitting device such as host bus adapter 402 of FIG. 4, and receiver 504 may be a receiving device such as expander 406 of FIG. 4. Transmission components 508 sends the serial data signal from transmitter 502 to receiver 504. Transmission components 508 may include amplifiers, buffers, oscillators, timers, clocks, registers, logic, state machines, and other signal generation hardware.

Receiver components 510 receive the transmitted data signal flowing into receiver 504. The signal is passed to a Cyclical Redundancy Checking (CRC) check 512. Cyclical redundancy checking is an error checking technique used to ensure the accuracy of transmitting digital data. The transmitted messages are divided into predetermined lengths which, used as dividends, are divided by a fixed divisor. The remainder of the calculation is appended onto and sent with the message. At the receiving end, CRC check 512 recalculates the remainder. If the remainder does not match the transmitted remainder, an error is detected and sent to error report logic 514.

Receiver 504 also uses parity check 516 interconnected with CRC check 512 and error report logic 514 to ensure data is properly received by receiver components 510. Parity check 516 checks the validity of data as it moves from one location to another. Parity for transmitter 502 and receiver 504 system may be specified as even or odd. Any data which contains an odd number of bits will be given one extra check bit in an even parity system. Parity check 516 can therefore recognize quickly whether any bit of information has been dropped or picked up as data has been moved and report that information to error report logic 514. Error report logic 514 uses the applicable data transmission protocols to both generate and compile transmission errors and information regarding transmission errors and sends that information to receiver's transmission components 518.

Receiver's transmission components 518 sends necessary data and an error report back to transmitter 502 to transmitter's receiving components 520 functioning similar to transmission components 508. Transmitter's receiving components 520 receive data flowing into transmitter 502 from receiver 504. The incoming signal is passed to amplitude logic 522. Amplitude logic 522 uses the error reporting from receiver 504 to determine whether the drive strength of transmission components 508 should be increased. Amplitude logic 522 instructs amplitude control 524 to request an increase in amplitude if necessary. Amplitude logic 522 also determines whether an increase in signal amplitude is possible or whether the drive strength is at the maximum level. Amplitude control 524 sends an instruction to a control register or other control element within transmission components 508 instructing the increase or decrease in drive strength.

In another illustrative embodiment of the present invention both transmitter 502 and receiver 504 may include amplitude control 524, amplitude logic 522, CRC check 512, error report logic 514, and parity check 516. As a result, both transmission components 508 and receiver's transmission components 518 may increase amplitude drive strength for effective communications between the two devices. Both transmitter 502 and receiver 504 or each device could individually adjust amplitude settings for optimal serial communications. For example, receiver 504 may check incoming data for errors and then instruct transmission components 508 indirectly to increase the drive strength. In another example, transmitter 502 may automatically increase the drive strength if no communication is received from receiver 504 with a specified time period.

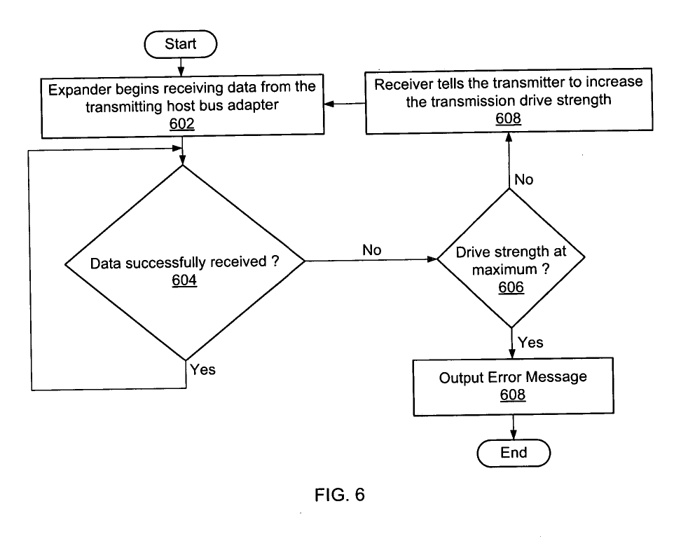

FIG. 6 is a flowchart illustrating amplitude modification in a receiving expander in accordance with an illustrative embodiment of the present invention. The steps illustrated in FIG. 6 may be partially or fully implemented by a state machine or logic in a device such as expander 406 of FIG. 4. In one illustrative embodiment, the process, state machine, or logic illustrated in FIG. 6 is implemented in firmware. In one embodiment, the process of FIG. 6 occurs automatically when data is being sent from the transmitter to the receiver.

In another illustrative embodiment, a training link or training sequence may be established between a transmitter and receiver after the receiver has been connected to the transmitter. The training sequence may occur before or after the timing and emphasis settings have been optimized. Dynamic amplitude modification establishes the optimal amplitude settings before the system incorporating the transmitter and receiver has established a reliance on the interconnection.

The process begins as the expander receives data from the transmitting host bus adapter (step 602). The expander first determines whether the data is being successfully received (step 604). The expander may use various ways to determine if the received signal is within the necessary signal threshold and intelligible. For example, the expander may use amplitude peak detection to determine whether the range is appropriate. In another example, the expander may use standard error detection and parity control to determine whether the data is intelligible. The expander may have established threshold error levels that indicate that indicate when amplitude modification is necessary. The expander may send an error message to the transmitting host bus adapter indicating that the data is not being successfully received.

In another illustrative embodiment a timer may be used so that if a signal is not successfully received by the transmitting host bus adapter within a specified time period the data is deemed to be unsuccessfully received. The timer may include a default value, a system or protocol specific time period, or may be user specified.

If the data is successfully received in step 604, there is no need for amplitude modification and step 604 repeats in a loop to continuously ensure that data is not lost.

If the data is not received successfully in step 604, there is a need for amplitude modification. The receiver determines whether the drive strength is at the maximum level (step 606). The drive strength determination made may be based on information such as previous amplitude modification requests, communications from the transmitting host bus adapter, or default settings. If the drive is not at maximum strength in step 606, the receiving expander tells the transmitting host bus adapter to increase the transmission drive strength (step 608). As previously described, the transmitting host bus adapter preferably has various amplitude settings so that the drive strength may be increased or decreased incrementally. The drive strength may be changed by sending a change register request to a specified register within the transmitting host bus adapter. After the drive strength has been increased (step 608), the process returns to the expander receiving data from the transmitting host bus adapter (step 602).

If the drive is at maximum strength in step 606, an output error message is signaled to the software level so that the user is aware of the problem before the process ends.

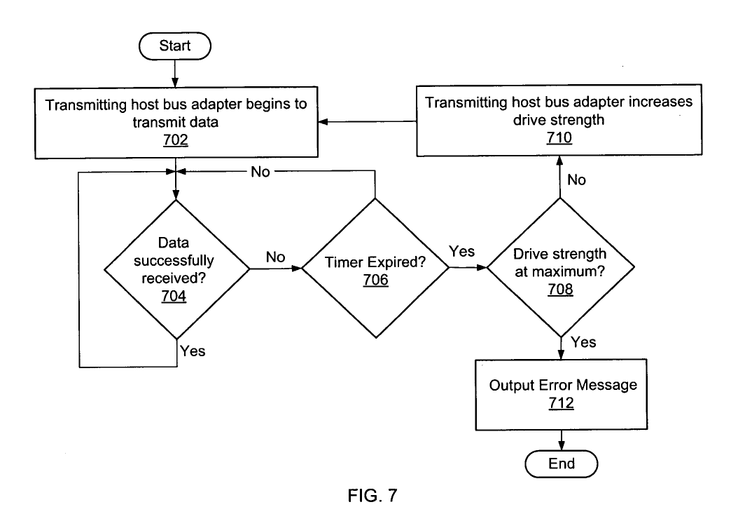

FIG. 7 is a flowchart illustrating amplitude modification in a transmitting host bus adapter in accordance with an illustrative embodiment of the present invention. The process begins as the transmitting host bus adapter sends data to a receiving expander (step 702). The transmitter then determines whether the data is being received successfully (step 704).

If the data is successfully received in step 704, there is no need for amplitude modification and step 704 continues to loop ensuring that no data is lost because of insufficient signal amplitude. As the transmitting host bus adapter begins to transmit data (step 702), a timer in the transmitting host bus adapter is started. The timer is preprogrammed with a specified time period during which the transmitting host bus adapter attempts to communicate with the receiving expander. If the data is not received successfully in step 704, the transmitter uses the timer to determine whether the specified time has expired (step 706). If the timer has not yet expired in step 706, the transmitting device continues to determine if the data has been successfully received (step 704).

If the timer has expired in step 706, the transmitting host bus adapter determines whether the drive strength is at the maximum level (step 708). If the drive is not at maximum strength in step 708, the transmitting host bus adapter increases the transmission drive strength (step 710). Increasing the drive strength based on not receiving packets in a specified time period allows the transmitting host bus adapter to automatically increase the drive strength if communication between the receiving expander is not received. After the drive strength has been increased (step 710), the transmitting host bus adapter begins again to transmit data.

If the drive is at maximum strength in step 708, an output error message is signaled to the software level (step 712) so that the user is aware of the problem before the process ends.

The steps illustrated in FIG. 7 may be implemented by a state machine or logic in a device such as host bus adapter 402 of FIG. 4 and transmitter 502 of FIG. 5.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer implemented method of increasing drive strength, the computer implemented method comprising:
receiving a data signal at a receiving device;
responsive to receiving the data signal at the receiving device, determining if the data signal is successfully received; and
responsive to determining the data signal is unsuccessfully received, requesting an increase in a signal amplitude of the data signal transmitted by a transmitting device that sent the data signal for increasing the drive strength.

2. The computer implemented method of claim 1, wherein the determining step comprises determining if the signal amplitude is sufficiently high for data to be extracted from the data signal by the receiving device.

3. The computer implemented method of claim 1, wherein the receiving device is any of a host bus adapter, expander, disk drive, tape drive, peripheral component interconnect (PCI) express , Ethernet target, Fibre switch or a computer.

4. The computer implemented method of claim 1, further comprising determining whether the drive strength is at a maximum level.

5. The computer implemented method of claim 4, wherein the requesting step only occurs if the drive strength is not at a maximum level.

6. The computer implemented method of claim 5, comprising outputting an error message to a user if the data signal is unsuccessfully received and the drive strength is at the maximum level for indicating a connection error.

7. The computer implemented method of claim 1, wherein the drive strength includes a plurality of incremental values.

8. The computer implemented method of claim 1, comprising:
beginning a timer when the transmitting device begins to send the data signal, wherein the timer counts down a specific time period;
responsive to determining the transmitted signal is unsuccessfully received within the specific time period and the drive strength is at the maximum level, incrementing the drive strength of the transmitting device.

9. The computer implemented method of claim 1, wherein the requesting step comprises sending an error message according to a data transmission protocol.

10. The computer implemented method of claim 1, wherein the drive strength is increased from a default level.

11. The computer implemented method of claim 10, wherein the default level is a minimum drive strength so that the drive strength is increased incrementally until the data signal is received successfully for conserving power and minimizing electromagnetic interference.

12. The computer implemented method of claim 1, wherein the requesting step comprises sending a register change request indicating that the drive strength is to be increased.

13. The computer implemented method of claim 1, wherein the requesting step comprises sending a manual request from a remote location to increase the drive strength.

14. An apparatus comprising:
a controller;
a bus interface for sending a data signal, wherein the bus interface is operably connected to the controller, wherein the bus interface increases a drive strength in response to an error message; and
an expander operably connected to the bus interface by a conductor for serial data transmissions for routing data to at least one device, wherein the expander receives a data signal from the bus interface, determines if the data signal is successfully received, and sends an error message to the bus interface for indicating the data signal was unsuccessfully received.

15. The apparatus of claim 14, wherein the bus interface further comprises a timer wherein the timer counts down a specific time period and incrementally increases the drive strength when the transmitted data signal is unsuccessfully received within the specific time period for automatically adjusting the drive strength when the bus interface and expander are unable to communicate.

16. The apparatus of claim 14, wherein the host bus adapter further comprises a register, wherein a register change request indicates whether the drive strength is increased or decreased, wherein the register change request is hexadecimal value, wherein each hexadecimal value corresponds to an incremental value within a range of the drive strength.

17. The apparatus of claim 14, wherein the host bus adapter and expander communicate by a data transmission protocol using at least one of serial advanced technology attachment, serial attached small computer system interface transmission standards, and peripheral component interconnect Express.

18. A computer program product comprising a computer usable medium including computer usable program code for increasing a drive strength, said computer program product including:
computer usable program code for receiving a data signal at a receiving device;
computer usable program code, responsive to receiving the data signal, for determining if data signal is successfully received; and
computer usable program code, responsive to determining the data signal is unsuccessfully received, for requesting an increase in a signal amplitude of the data signal transmitted by a transmitting device that sent the data signal for increasing the drive strength.

19. The computer program product of claim 18, comprising:
computer usable code for beginning a timer when the transmitter begins to send the data signal, wherein the timer counts down a specific time period;
computer usable code, responsive to determining the transmitted signal is unsuccessfully received within the specific time period and the drive strength is at the maximum level, for incrementing the drive strength.

20. The computer program product of claim 19, the computer usable program code for requesting comprises sending an error message to the transmitting device.
